(19) United States
(12) Patent Application Publication
(10) Pub. No.: US 2015/0003288 A1
(43) Pub. Date: Jan. 1, 2015

(54) VDP REQUEST PACKET PROCESSING

(71) Applicant: Hangzhou H3C Technologies Co., Ltd., Hangzhou, Zhejiang (CN)

(72) Inventor: Qiang Wu, Haidian District (CN)

(21) Appl. No.: 14/374,273

(22) PCT Filed: Jul. 4, 2013
(86) PCT No.: PCT/CN2013/078785

§ 371 Date: Jul. 24, 2014

(30) Foreign Application Priority Data
Jul. 16, 2012 (CN) 201210244418.8

(51) Int. Cl. H04L 12/24

(52) U.S. Cl. CPC H04L 41/0866; H04L 41/0813
USPC 370/254

(57) ABSTRACT

A method and an edge switch for processing a VDP request packet are provided. The edge switch receives a notification for changing traffic features and a VDP request packet from a data server, determines filter information to be changed according to filter information in the VDP request packet, requests a VSI management server to process a VSI configuration and strategy according to the filter information to be changed, receiving a response from the VSI management server and processing the VSI configuration and strategy according to the filter information to be changed.

### BACKGROUND

With the development of data center services, virtualization of data center resources becomes an important trend in integration of the data center. Based on Edge Virtual Bridge (EVB) technology, tasks of traffic exchange and processing implemented by a Virtual Machine (VM) are, whenever possible, allocated to an edge switch directly connected with a server. For instance, the traffic exchange may be among VMs on a unified physical server.

### BRIEF DESCRIPTION OF THE DRAWINGS

FIG. 1a is a flow chart illustrating a first method for processing a VDP request packet in accordance with an example of the present disclosure;

FIG. 1 is a flow chart illustrating a second method for processing a VDP request packet in accordance with an example of the present disclosure;

FIG. 2 is a flow chart illustrating a third method for processing a VDP request packet based on a filter information status field in accordance with an example of the present disclosure;

FIG. 3 is a schematic diagram illustrating a TLV format of a VDP request packet in accordance with an example of the present disclosure;

FIG. 4 is a schematic diagram illustrating structure of an edge switch for processing a VDP request packet in accordance with an example of the present disclosure; and

FIG. 5 is a schematic diagram illustrating hardware structure of an edge switch for processing a VDP request packet in accordance with an example of the present disclosure.

### DETAILED DESCRIPTION

For simplicity and illustrative purposes, the present disclosure is described by referring to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used throughout the present disclosure, the term “includes” means includes but not limited to, the term “including” means including but not limited to. The term “based on” means based at least in part on. In addition, the terms “a” and “an” are intended to denote at least one of a particular element.

In one example, the function of the EVB may be implemented by a server and an edge switch via three protocols. The three protocols include an S Channel Discovery and Configuration Protocol (CDCP), an Edge Control Protocol (ECP), and a Virtual Station Interface (VSI) Discovery and Configuration Protocol (VDP). The server negotiates with the edge switch using the VDP, to associate the VSI of the VM with an interface on the edge switch.

The VSI is an interface for sending and receiving traffic on the VM. Therefore, traffic supervision, traffic strategy arrangement, unified management and deployment of the VM may be achieved via supervision and control of the VSI. In EVB technology, the supervision and control strategy of the VSI is stored in a database of a VSI management server. When a VM is created or migrates, the VSI management server is searched for the supervision and control strategy, which is then configured on the edge switch connected with the VM. The configuration process includes associating the VSI with the edge switch, which may supervise and control the traffic of the VM instead of the VSI management server.

A VDP request packet is initiated by a server. The VDP request packet initiated by the server includes: pre-association, resource reservation pre-association, association and de-association. During the interaction process, when an association request is accepted, the server keeps sending an association request which is taken as a keep-alive packet. If it is detected that a VSI service instance ID and a VSI Type ID in the received association request are the same as those stored in advance, the edge switch updates the current status of the VSI, and does not sends a strategy request to the VSI management server. The processing method of the pre-association packet is similar to that mentioned above. The server sends a pre-association packet, in which the VSI service instance ID and VSI Type ID are the same as those in the association request. The pre-association packet is taken as the keep-alive packet.

Based on the requirements of a service application on the VM, traffic features of the VSI may change. For instance, a traffic feature may be added or deleted. The change of traffic features may be indicated using filter information in a VDP request packet, and it is desirable that the unchanged traffic of the VM is not affected. In this situation, the server sends the VDP request packet to the edge switch. Although the filter information of the VSI changes, since the VSI service instance ID is the same as the VSI Type ID, the edge switch takes the VDP request packet as the keep-alive packet.

If a traffic feature is added or deleted, the server may perform the de-association first and then establish a new association, or establish the pre-association first and then establish the new association.

The present disclosure provides a method for processing a VDP request packet. The method includes the following blocks.

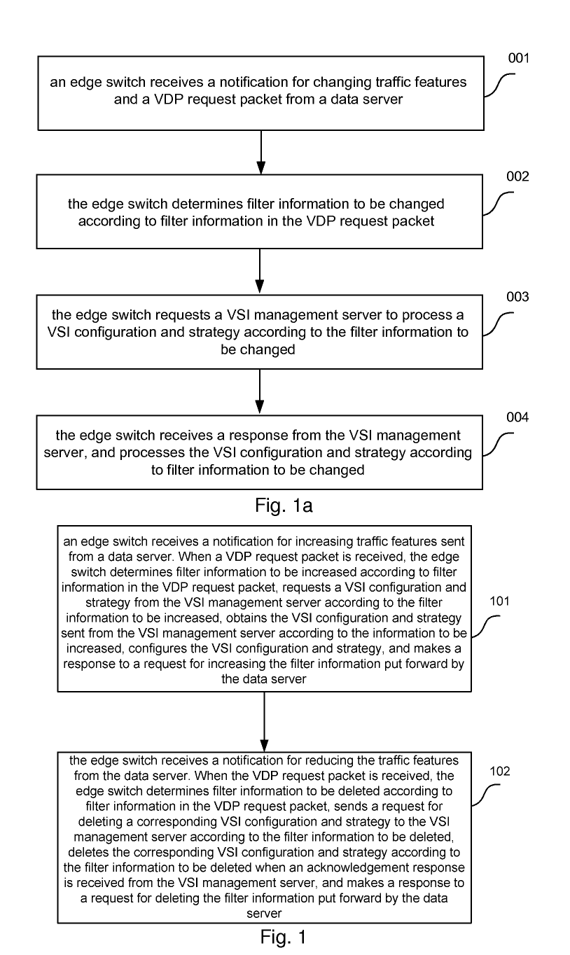

Referring to FIG. 1a, FIG. 1a is a flow chart illustrating a first method for processing a VDP request packet in accordance with an example of the present disclosure.

In block 001, an edge switch receives a notification for changing traffic features and a VDP request packet from a data server.

In block 002, the edge switch determines filter information to be changed according to filter information in the VDP request packet.

In block 003, the edge switch requests a VSI management server to process a VSI configuration and strategy according to the filter information to be changed.

In block 004, the edge switch receives a response from the VSI management server, and processes the VSI configuration and strategy according to filter information to be changed.

The present disclosure provides a method for processing the VDP request packet. The method may process the change of traffic features relatively quickly without causing traffic interruption. In this example, the above notification for changing the traffic features may be a notification for increasing the traffic features or for reducing the traffic features. The method may be applied to an EVB network. The EVB network includes a data server, an edge switch and a VSI management server. The data server may be used for storing user service data. The VSI management server may be used for storing supervision and control strategy of the VSI.

Referring to FIG. 1, FIG. 1 is a flow chart illustrating a second method for processing a VDP request packet in accordance with an example of the present disclosure.

In block 101, an edge switch receives a notification for increasing traffic features from a data server. When a VDP request packet is received, the edge switch determines filter information to be increased according to filter information in the VDP request packet, requests a VSI configuration and strategy from the VSI management server according to the filter information to be increased, receives the VSI configuration and strategy from the VSI management server according to the filter information to be increased, configures the VSI configuration and strategy, and responds to a request by the data server for increasing the filter information.

In this block, the notification for increasing the traffic features received by the edge switch from the data server may be carried in the VDP request packet, or a VDP notification packet.

In block 102, the edge switch receives a notification for reducing traffic features from the data server. When the VDP request packet is received, the edge switch determines filter information to be deleted according to filter information in the VDP request packet, sends a request for deleting a corresponding VSI configuration and strategy to the VSI management server according to the filter information to be deleted, deletes the corresponding VSI configuration and strategy according to the filter information to be deleted when an acknowledgement response is received from the VSI management server, and responds to a request by the data server for deleting the filter information.

In this block, the notification for reducing the traffic features received by the edge switch from the data server may be carried in the VDP request packet, or the VDP notification packet.

It should be noted that the execution order of the blocks 101 and 102 may be arbitrary, and blocks 101 and 102 may not be executed simultaneously. Their execution order is determined according to a received notification.

In another example, the edge switch receives a notification for keeping the traffic features unchanged from the data server, or does not receive a notification. When the VDP request packet is received, the subsequent processing is performed by the edge switch according to the type of the VDP request packet. The notification for keeping the traffic features unchanged received by the edge switch may be carried in the VDP request packet or VDP notification packet.

The above-mentioned notification for increasing the traffic features, the notification for reducing the traffic features and the notification for keeping the traffic features unchanged in the above VDP request packet may be distinguished by filter information in the VDP request packet, such as a filter information status field. The filter information status field may be placed between a filter format field and a filter information field of the VDP request packet.

In one example, the VDP request packet may be processed based on the filter information status field to indicate changing the traffic features as follows.

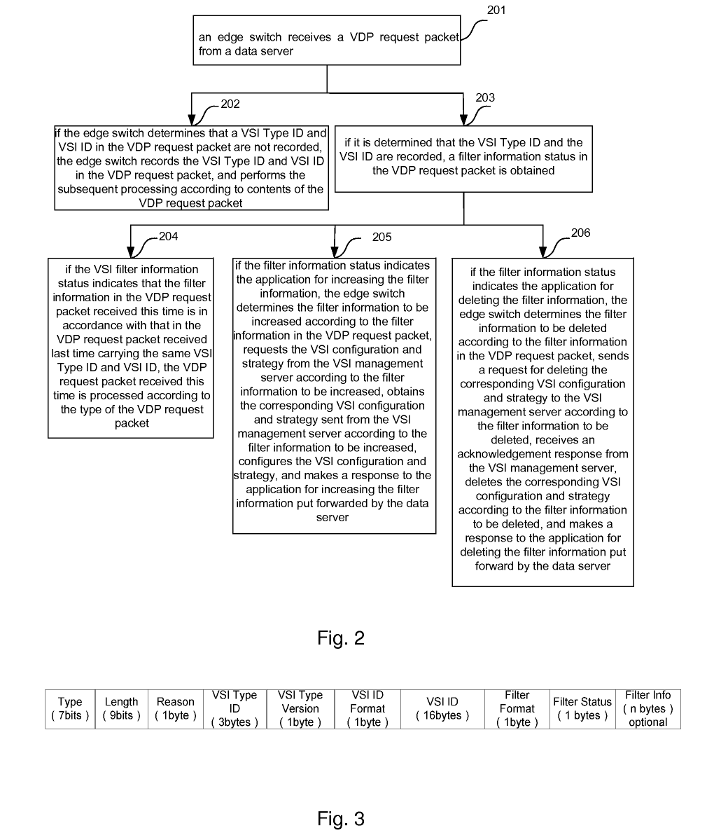

Referring to FIG. 2, FIG. 2 is a flow chart illustrating a third method for processing a VDP request packet in accordance with an example of the present disclosure.

In block 201, an edge switch receives a VDP request packet from a data server.

The VDP request packet in this block includes a VDP pre-association request packet, a resource reservation pre-association request packet, an association request packet and a de-association request packet.

In block 202, if the edge switch determines that a VSI Type ID and VSI ID in the VDP request packet are not recorded, the edge switch records the VSI Type ID and VSI ID in the VDP request packet, and performs the subsequent processing according to contents of the VDP request packet.

In this block, if the packet carrying the VSI Type ID and the VSI ID is received for the first time, the VSI Type ID and the VSI ID need to be recorded because they have been not recorded locally. In this case, the packet received for the first time may be a VDP pre-association request packet or VDP association request packet. The VDP pre-association request packet and the VDP resource reservation pre-association packet are referred to as the VDP pre-association request packet. When the data server sends the VDP request packet, the VDP pre-association request packet may be sent out first, followed by the VDP association packet. In the alternative, the VDP association packet is directly sent out.

In this block, the received VDP request packet is processed according its contents. The processing includes: if the VDP pre-association request packet or the VDP association packet is received for the first time, requesting the VSI management server for the VSI configuration and strategy according to the filter information in the packet. The VSI management server sends the VSI configuration and strategy recorded in its VSI Type database (VTDB) to the edge switch according to the filter information in the request packet, and the edge switch performs the configuration according to the VSI configuration and strategy sent from the VSI management server.

In block 203, if it is determined that the VSI Type ID and the VSI ID are already recorded locally, a filter information status in the VDP request packet is obtained.

In this block, the obtained filter information status may be placed in any location of a Type-Length-Value (TLV) of the VDP request packet. For instance, the filter information status may be placed after a filter information format and before filter information according to a habit or convention for reading associated information). That is, when the data server sends the VDP request packet, the filter information status is placed between the filter information format and the filter information for transmission.

Referring to FIG. 3, FIG. 3 is a schematic diagram illustrating a TLV format of a VDP request packet in accordance with an example of the present disclosure. The value of the ‘Type’ in FIG. 3 indicates the type of the VDP request packet. ‘Length’ indicates the length of the TLV. ‘Reason’ indicates a status/error code. A strategy corresponding to each VSI Type ID is defined by the VSI management server, and may be applied to multiple VSI service instances. A ‘VSI Type Version’ indicates a version of a VSI type, and is used for defining and updating a VSI database. A ‘VSI ID format’ may be IPv4, IPv6 or MAC, etc. The ID of each VSI ID' is different. The value of the VSI ‘filter format’ indicates the VLAN, MAC plus VLAN, etc. The value of ‘VSI filter information’ is determined by a type of feature information.

Different values may be given to a newly-increased VSI filter information status to indicate different meaning. As explained in the following examples, a filter information status of 0x00 may be used to indicate no change, 0x01 to indicate an increase and 0x20 to indicate a decrease.

If the value of the VSI filter information status is 0x00, this indicates that the filter information in the VDP request packet received this time is in accordance with the filter information in the VDP request packet carrying the same VSI Type ID and the VSI ID received previously. In this situation, the filter information field is not read. Therefore, the filter information may have information or may be empty. When the server sends out the keep-alive information, or when the pre-association request packet is converted into the association request packet, the value of the VSI filter information status is used. When the edge switch detects that the value of the newly-increased VSI filter information status is zero, the application is not sent to the VSI management server and is processed. Furthermore, the de-association request may also use this value.

If the value of the VSI filter information status is 0x01, the VSI filter information status indicates an application for increasing the filter information. In this situation, the filter information field should be filled with a value. The value is used when the server sends the association or pre-association application for the first time. If the VSI runs stably and new traffic features need to be increased, the value is used. When the value is detected, the edge switch sends an application to the VSI management server, requests the VSI management server to set the strategy on the newly-increased traffic features of the VSI service instance. Depending on the strategy setting resources at the VSI management server, the application may not be successful. The edge switch notifies the server of the result of this application according to the response of the VSI server.

If the value of the VSI filter information status is 0x02, the VSI filter information status indicates an application for deleting the filter information. In this situation, the filter information field should be filled with a value. The value should not be used when the association or pre-association application is sent for the first time. Once the VSI runs stably and traffic features need to be deleted, this value is used. When the value is detected, the edge switch sends an application to the VSI management server to request the VSI management server to delete the VSI configuration and strategy of the filter information.

In block 204, if the VSI filter information status indicates that the filter information in the VDP request packet received this time is in accordance with that in the VDP request packet received previously and carrying the same VSI Type ID and VSI ID, the VDP request packet received this time is processed according to the type of the VDP request packet.

In this block, the method for processing the VDP request packet received this time according to the type of the VDP request packet includes: processing the VDP request packet taken as the keep-alive packet if the VDP request packet received this time is the pre-association request packet. The processing includes updating the current status of the VSI. If the VDP request packet received this time is the VDP association request packet and the recorded type of the VDP request packet is the pre-association request packet, the status of the invalid VSI configuration and strategy corresponding to the local VSI is configured as valid, and a response is made to a VDP association request of the data server. If the VDP request packet received this time is the VDP association request packet and the recorded type of the VDP request packet is the association request packet, the packet taken as the keep-alive packet is processed. If the VDP request packet received this time is the de-association request packet, the VSI configuration and strategy corresponding to the VSI is deleted, and a notification is sent to the VSI management server, and a response is made to the VDP de-association request of the data server.

In block 205, if the filter information status indicates an application for increasing the filter information, the edge switch determines the filter information to be increased according to the filter information in the VDP request packet, requests the VSI configuration and strategy from the VSI management server according to the filter information to be increased, obtains the corresponding VSI configuration and strategy sent from the VSI management server according to the filter information to be increased, configures the VSI configuration and strategy, and responds to the application by the data server for increasing the filter information.

In block 202, when the VSI Type ID and VSI ID in the VSP request packet received this time are recorded, the filter information in the VDP request packet received this time is further recorded.

In this block, the method for determining the filter information to be increased according to the filter information in the VDP request packet includes: comparing the filter information in the VDP request packet with the recorded filter information, and determining that the filter information included in the VDP request packet, but not included in the recorded filter information, is the filter information to be increased.

If a to-be-increased traffic list is filled in with the filter information to be increased, that filter information is taken as the filter information to be increased. If the to-be-increased traffic list is filled in with all filter information, i.e. the filter information to be increased and the original filter information, all of the filter information needs to be compared with the recorded filter information to obtain the filter information to be increased.

In block 206, if the filter information status indicates the application for deleting the filter information, the edge switch determines the filter information to be deleted according to the filter information in the VDP request packet, sends a request for deleting the corresponding VSI configuration and strategy to the VSI management server according to the filter information to be deleted, receives an acknowledgement response from the VSI management server, deletes the corresponding VSI configuration and strategy according to the filter information to be deleted, and responds to the data server's application for deleting the filter information.

In this block, the method for determining the filter information to be deleted according to the filter information in the VDP request packet includes determining the filter information in the VDP request packet as the filter information to be deleted.

Alternatively, the filter information in the VDP request packet is compared with the recorded filter information, and the filter information which is included in the recorded filter information but not included in the VSP request packet is determined as the filter information to be deleted.

In this block, the method for deleting the filter information is similar to that for increasing the filter information in block 205. The information added to a to-be-deleted traffic list is the filter information to be deleted. If the information added to the to-be-deleted traffic list is the deleted filter information, the deleted filter information is compared to the recorded filter information to determine the filter information to be deleted. One of the above two methods may be used.

In block 205, when the obtained VSI configuration and strategy is configured, the method further includes adding the filter information corresponding to the obtained VSI configuration and strategy to the filter information recorded. In block 206, when the corresponding VSI configuration and strategy is deleted from the local according to the filter information to be deleted, the method further includes deleting the filter information corresponding to the VSI configuration and strategy to be deleted from the filter information recorded.

The present disclosure provides an edge switch. The edge switch includes a processor and a packet processing chip.

In one example, the processor is to:

receive, via the packet processing chip, a notification for changing traffic features and a VDP request packet from a data server via an interface;

determine filter information to be changed according to filter information in the VDP request packet,

request a VSI management server to process a VSI configuration and strategy according to the filter information to be changed,

receive a response from the VSI management server via the packet processing chip, and

process the VSI configuration and strategy according to the filter information to be changed.

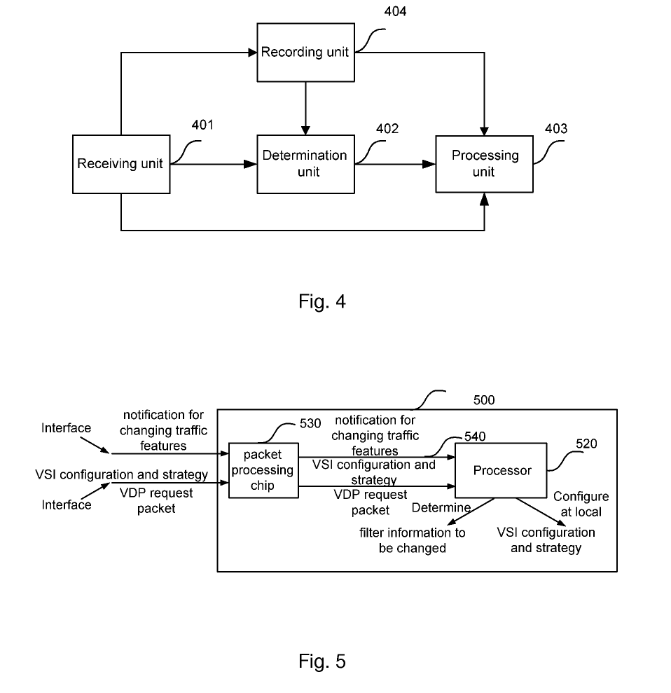

An example of the present disclosure further provides an edge switch, applied to the EVB network. The EVB network includes a data server and a VSI management server. Referring to FIG. 4, FIG. 4 is a schematic diagram illustrating structure of an edge switch for processing a VDP request packet in accordance with an example of the present disclosure. The edge switch includes a receiving unit 401, a determination unit 402 and a processing unit 403.

The receiving unit 401 is to receive a notification for increasing traffic features, a notification for reducing traffic features and a VDP request packet sent from the data server.

The determination unit 402 is to:

determine filter information to be increased according to filter information in the VDP request packet when the receiving unit 401 receives the notification for increasing the traffic features from the data server and when the VDP request packet is received, and

determine the filter information to be deleted according to the filter information in the VDP request packet when the receiving unit 401 receives the notification for reducing the traffic features from the data server and when the VDP request packet is received.

The processing unit 403 is to:

request a VSI configuration and strategy from the VSI management server according to the filter information to be increased when the determination unit 402 determines the filter information to be increased according to the filter information in the VDP request packet,

obtain the VSI configuration and strategy from the VSI management server according to the filter information to be increased,

configure the VSI configuration and strategy, and

responds to an application by the data server for increasing the filter information;

send a request for deleting the corresponding VSI configuration and strategy to the VSI management server according to the filter information to be deleted when the determination unit 402 determines the filter information to be deleted according to the filter information in the VDP request packet,

receive an acknowledgement response from the VSI management server, delete the corresponding VSI configuration and strategy according to the filter information to be deleted, and

responds to an application by the data server for deleting the filter information.

The receiving unit 401 is further to receive a notification for keeping the traffic features unchanged from the data server.

The processing unit 403 is further to process the VDP request packet according to the type of the VDP request packet if the notification for keeping the traffic features unchanged is received from the receiving unit 401, or is not received.

The above notification for increasing the traffic features may be carried in the VDP request packet, or the VDP notification packet. The above notification for reducing the traffic features may be carried in the VDP request packet, or the VDP notification packet. The above notification for keeping the traffic features unchanged may be carried in the VDP request packet, or the VDP notification packet.

The above mentioned notification for increasing the traffic features, the notification for reducing the traffic features and the notification for keeping the traffic features unchanged in the above VDP request packet may be distinguished by a filter information status field. The filter information status field may be placed after the filter information format field and before the filter information field of the VDP request packet.

The edge switch is further to include a recording unit 404.

The recording unit 404 is to record the VSI Type ID and VSI ID in the VDP request packet when the receiving unit 401 receives the VDP request packet and record and update the type of the VDP request packet.

The processing unit 403 is further to process the VDP request packet taken as a keep-alive packet when the VDP request packet received this time is a VDP pre-association request packet. If the VDP request packet received this time is the VDP association request packet and the type of the VDP request packet recorded by the recording unit 404 is a pre-association request packet, the processing unit 403 is to configure the invalid VSI configuration and strategy corresponding to the VSI as valid, update the recorded type of the VDP request packet, and respond to the VDP association request of the data server. If the VDP request packet received this time is the VDP association request packet and the type of the VDP request packet recorded by the recording unit 404 is the association request packet, the processing unit 403 processes VDP request packet taken as the keep-alive packet. If the VDP request packet received this time is a VDP de-association request packet, the processing unit 403 deletes the VSI configuration and strategy corresponding to the VSI, notifies the VSI management server of the deletion, and responds to the VDP de-association request packet.

The determination unit 402 is further to determine that the filter information in the VDP request packet is the filter information to be increased or deleted.

The recording unit 404 is further to record the VSI Type ID, VSI ID and filter information in the VDP request packet.

The determination unit 502 is further to:

compare the filter information in the VDP request packet with the filter information which corresponds to the VSI Type ID and the VSI ID and is recorded in the recording unit 404, and determine that the filter information which is included in the VDP request packet but not included in the recorded filter information is the filter information to be increased; and

compare the filter information in the VDP request packet with that recorded in the recording unit 404, and determine that the filter information which is included in the recorded filter information but not included in the VDP request packet is the filter information to be deleted.

The above example units may be integrated or implemented in one physical entity and may be deployed separately, may be combined to a unit and may further be split into a plurality of sub-units.

The edge switch for processing the VDP request packet is described in the above example of the present disclosure. Hardware structure of the edge switch for processing the VDP request packet in an example of the present disclosure is given hereafter. The edge switch may be a programmable device with the hardware structure and software program. Referring to FIG. 5, FIG. 5 is a schematic diagram illustrating hardware structure of an edge switch 500 for processing a VDP request packet in accordance with an example of the present disclosure. The edge switch 500 includes processor 520, a packet processing chip 530, and a connection 540 between the processor 520 and the packet processing chip 530.

The processor 520 is to implement functions implemented by the processing unit 403 and the determination unit 402 in the above edge switch and process the packet received via the packet processing chip 530.

The packet processing chip 530 is to connect with the VSI management server and the data server via an interface on the chip and forward the packet. The packet processing chip 530 is to receive and send the VDP request packets (including the VDP pre-association request packet, the VDP association request packet and the VDP de-association request packet) and/or receive the VDP notification packet, responds to the data server, receive the notification from the data server, and is responsible for receiving and sending interaction packets between the packet processing chip 530 and the VSI management server.

The edge switch 500 further includes a memory to record the VSI Type ID, VSI ID and filter information in the VDP request packet, and to record and update the type of the VDP request packet.

It should be noted that FIG. 5 illustrates an example of the edge switch for processing the VDP request packet. The edge switch may also be implemented with other structure different from that of this example. For instance, the operation for executing the above codes may also be implemented with an Application Specific Integrated Circuit (ASIC). The edge switch 500 may include one or multiple processors 520. If there are multiple processors, the instruction codes are read and executed by the multiple processors 520. Therefore, the present disclosure does not limit the structure of the edge switch for processing the VDP request packet.

In view of the above examples of the present disclosure, when the notification for increasing the traffic features or the notification for reducing the traffic features sent from the data server is received, the filter information to be increased or the filter information to be reduced is determined according to the received VDP request packet. The edge switch interacts with the VSI management server, the VSI management server sends the corresponding VSI configuration and strategy to the edge switch and the edge switch deletes the VSI configuration and strategy corresponding to the filter information to be deleted. The present disclosure may process the change of the traffic features quickly without causing traffic interruption, and may assist a virtual server in deploying a new server quickly.

The notification for changing the traffic features may be carried in the VDP request packet or the VDP notification packet. The change of the traffic features, for instance, is to increase, reduce or keep the traffic features unchanged. The type of change may be indicated by allocating different values to a field.

What has been described and illustrated herein are examples of the disclosure along with some variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated

What is claimed is:

1. A method for processing a Virtual Station Interface Discovery and Configuration Protocol (VDP) request packet, comprising an edge switch:
receiving a notification for changing traffic features and a VDP request packet from a data server,
determining filter information to be changed according to filter information in the VDP request packet,
requesting a VSI management server to process a VSI configuration and strategy according to the filter information to be changed, and
receiving a response from the VSI management server, and processing the VSI configuration and strategy according to the filter information to be changed.

2. The method according to claim 1, wherein the notification for changing the traffic features comprises a notification for increasing the traffic features; and
determining the filter information to be changed according to the filter information in the VDP request packet, requesting the VSI management server to process the VSI configuration and strategy according to the filter information to be changed, receiving the response from the VSI management server and processing the VSI configuration and strategy according to the filter information to be changed comprises:
determining filter information to be increased according to the filter information in the VDP request packet, requesting the VSI configuration and strategy from the VSI management server according to the filter information to be increased, receiving the VSI configuration and strategy from the VSI management server and configuring the received VSI configuration and strategy.

3. The method according to claim 1, wherein the notification for changing the traffic features comprises a notification for reducing the traffic features; and
determining the filter information to be changed according to the filter information in the VDP request packet, requesting the VSI management server to process the VSI configuration and strategy according to the filter information to be changed, receiving the processing response from the VSI management server and processing the VSI configuration and strategy according to the filter information to be changed comprises:
determining filter information to be deleted according to the filter information in the VDP request packet, sending a request for deleting the VSI configuration and strategy according to the filter information to be deleted, receiving an acknowledgement response from the VSI management server and deleting the VSI configuration and strategy corresponding to the filter information to be deleted.

4. The method according to claim 1, further comprising:
processing, by the edge switch when the VDP request packet is received, the VDP request packet according to a type of the VDP request packet if the edge switch receives a notification for keeping the traffic features unchanged from the data server or the edge switch does not receive a notification.

5. The method according to claim 4, wherein
the notification for increasing the traffic features is carried in the VDP request packet or a VDP notification packet;
the notification for reducing the traffic features is carried in the VDP request packet or the VDP notification packet; and
the notification for keeping the traffic features unchanged is carried in the VDP request packet or the VDP notification packet; wherein
a filter information status field in the VDP request packet indicates whether the received notification is for increasing the traffic features, for reducing the traffic features or for keeping the traffic features unchanged;
the filter information status field is placed between a filter format filed and a filter field of the VDP request packet.

6. The method according to claim 4, wherein when the VDP request packet is received, the method further comprises: recording a VSI Type ID and a VSI ID in the VDP request packet, recording and updating the type of the VDP request packet; and wherein processing the VDP request packet according to the type of the VDP request packet comprises:
processing the VDP request packet taken as a keep-alive packet if the VDP request packet is a VDP pre-association request packet, configuring an invalid VSI configuration and strategy as a valid VSI configuration and strategy, updating the recorded type of the VDP request packet and responding to a VDP association request of the data server if the VDP request packet is a VDP association request packet and the type of the recorded VDP request packet is a pre-association request packet,
processing the VDP request packet taken as the keep-alive packet if the VDP request packet is the VDP association request packet and the recorded type of the VDP request packet is an association request packet, deleting the VSI configuration and strategy corresponding to the VSI, notifying the VSI management server and making a response to a VDP de-association request of the data server if the VDP request packet is a de-association request packet.

7. The method according to claim 2, wherein when the VDP request packet is received, the method further comprises: recording a VSI Type ID, VSI ID and the filter information in the VDP request packet;
wherein determining the filter information to be increased according to the filter information in the VDP request packet comprises: comparing the filter information in the VDP request packet with filter information corresponding to the recorded VSI Type ID and VSI ID and determining that the filter information which is comprised in the VDP request packet but not comprised in the recorded filter information is the filter information to be increased.

8. The method according to claim 3, wherein when the VDP request packet is received, the method further comprises: recording a VSI Type ID, VSI ID and the filter information in the VDP request packet;
wherein determining the filter information to be deleted according to the filter information in the VDP request packet comprises: comparing the filter information in the VDP request packet with the recorded filter information and determining that the filter information which is comprised in the recorded filter information but not comprised in the VDP request packet is the filter information to be deleted.

9. An edge switch, comprising a processor and a packet processing chip; wherein
the processor is to receive, via the packet processing chip, a notification for changing traffic features and a VDP request packet sent from a data server via an interface; and
determine filter information to be changed according to filter information in the VDP request packet, request a VSI management server to process a VSI configuration and strategy corresponding to the filter information to be changed according to the filter information to be changed, receive a processing response from the VSI management server via the packet processing chip and process the VSI configuration and strategy according to the filter information to be changed.

10. The edge switch according to claim 9, wherein the notification for changing the traffic features comprises: a notification for increasing the traffic features; wherein
the processor is further to determine filter information to be increased according to the filter information in the VDP request packet, request the VSI configuration and strategy from the VSI management server according to the filter information to be increased via the packet processing chip, receive the VSI configuration and strategy corresponding to the filter information to be increased from the VSI management server via the packet processing chip and configure the received VSI configuration and strategy.

11. The edge switch according to claim 9, wherein the notification for changing the traffic features comprises a notification for reducing the traffic features; wherein
the processor is further to determine filter information to be deleted according to the filter information in the VDP request packet, send a request for deleting the VSI configuration and strategy corresponding to the filter information to be deleted to the VSI management server according to the filter information to be deleted via the packet processing chip, receive an acknowledgement response from the VSI management server via the packet processing chip and delete the VSI configuration and strategy corresponding to the filter information to be deleted from the local.

12. The edge switch according to claim 9, wherein
the processor is further to receive a notification for keep the traffic features unchanged from the data server via the packet processing chip; and
process the VDP request packet according to a type of the VDP request packet if the notification for keeping the traffic features unchanged is received from the data server or no notification is received.

13. The edge switch according to claim 12, wherein
the notification for increasing the traffic features is carried in the VDP request packet or a VDP notification packet;
the notification for reducing the traffic features is carried in the VDP request packet or VDP notification packet; and
the notification for keeping the traffic features unchanged is carried in the VDP request packet or VDP notification packet; wherein
a filter information status field in the VDP request packet indicates whether the received notification is for increasing the traffic features, reducing the traffic features or keeping the traffic features unchanged; and
the filter information status field is placed between a filter format filed and a filter field of the VDP request packet.

14. The edge switch according to claim 12, wherein the edge switch further comprises:
a storage, to record a VSI Type ID and a VSI ID in the VDP request packet, record and update the type of the VDP request packet; wherein
the processor is further to process the VDP request packet taken as a keep-alive packet if the VDP request packet is a VDP pre-association request packet, configure an invalid VSI configuration and strategy as a valid VSI configuration and strategy, update the recorded type of the VDP request packet and respond to a VDP association request of the data server via the packet processing chip if the VDP request packet is a VDP association request packet and the type of the recorded VDP request packet is a pre-association request packet, process the VDP request packet taken as the keep-alive packet if the VDP request packet is the VDP association request packet and the recorded type of the VDP request packet is an association request packet, delete the VSI configuration and strategy corresponding to the VSI, notify the VSI management server and make a response to a VDP de-association request of the data server via the packet processing chip if the VDP request packet is a de-association request packet.

15. The edge switch according to claim 10, further comprising:
a storage to record a VSI Type ID, VSI ID and the filter information in the VDP request packet;
the processor is further to compare the filter information in the VDP request packet with filter information corresponding to the recorded VSI Type ID and VSI ID and determine that the filter information in the VDP request packet but not in the recorded filter information is the filter information to be increased.

16. The edge switch according to claim 11, further comprising:
a storage to record a VSI Type ID, VSI ID and the filter information in the VDP request packet; and
the processor is further to compare the filter information in the VDP request packet with the recorded filter information and determine that the filter information in the recorded filter information but not in the VDP request packet is the filter information to be deleted.
